(19) United States
(12) Patent Application Publication
(10) Pub. No.: US 2023/0025800 A1
(43) Pub. Date: Jan. 26, 2023

(54) SYSTEM FOR INTELLIGENT FACILITATION OF SPEECH SYNTHESIS AND SPEECH RECOGNITION WITH AUTO-TRANSLATION ON SOCIAL MEDIA PLATFORM

(71) Applicants: Salah M. Werfelli, Morgan Hill, CA (US); Sam L. Appleton, Morgan Hill, CA (US); Tanwir Zafar Syedmohammad, Tracy, CA (US)

(72) Inventors: Salah M. Werfelli, Morgan Hill, CA (US); Sam L. Appleton, Morgan Hill, CA (US); Tanwir Zafar Syedmohammad, Tracy, CA (US)

(21) Appl. No.: 17/381,714

(22) Filed: Jul. 21, 2021

(51) Int. Cl. G10L 15/26; G10L 13/047; H04L 12/58

(52) U.S. Cl. CPC G10L 15/26; G10L 13/047; H04L 51/32

(57) ABSTRACT

The present invention relates to social media networking platform features. The present invention particularly relates to a system for the facilitation of speech synthesis i.e. text to speech or audio feature on a social media networking platform. The present invention further relates to the facilitation of speech recognition i.e. audio to text feature on social media networking platform. In addition, the aforementioned system also facilitates the feature of auto-translation in all languages to aid user operating in their own preferred language. Further, the aforementioned system enables sharing of content on its portal system while retaining the track and identity of the original creator of the content. The aforementioned system may be operated through all possible forms of multi-media platforms such as computers, laptops, mobiles, tablets etc.

### CROSS REFERENCE OF RELATED PATENTS

The current application claims benefit of U.S. Provisional Patent Application 63/054343 filed Jul. 21, 2020 and U.S. patent application Ser. No. 63/054355 filed Jul. 21, 2020.

### FIELD OF THE INVENTION

The present invention relates to social media networking platform features. The present invention particularly relates to a system for the facilitation of speech synthesis i.e. text to speech or audio feature on a social media networking platform. The present invention further relates to the facilitation of speech recognition i.e. audio to text feature on social media networking platform. In addition, the aforementioned system also facilitates the feature of auto-translation in all languages to aid user operating in their own preferred language. Further, the aforementioned system enables sharing of content on its portal system while retaining the track and identity of the original creator of the content. The aforementioned system may be operated through all possible forms of multi-media platforms such as computers, laptops, mobiles, tablets etc.

### BACKGROUND OF THE INVENTION

Social networking media have become a popular way for many individuals worldwide to socialise with each other. Typically, the social networking media allow social networking members to create their own online profile with data, pictures, videos and any other information and to communicate with each other by voice, chat, instant message, videoconferencing and so on. Therefore, social networking media provide a lot of information about their members.

Text-to-speech (TTS) synthesis is used in various different environments in which text is input or received at a device and audio speech output of the content of the text is output. For example, some instant messaging (IM) systems use TTS synthesis to convert text chat to speech. This is very useful for blind people, people or young children who have difficulties reading, or for anyone who does not want to change his focus to the IM window while doing another task.

It is pertinent to note that the social media platforms currently available are focused on providing users a platform to share personal and other users work on the network. The site allows users to share and forward articles posted by other users, but it provides no tracking and retention for the identity of the original creator of the content.

Further, social media platforms currently known do not any support and aid speed synthesis and speech recognition features with auto translation.

In view of the above, the present invention provides a revolutionary solution with system mentioned herein to over come the short comings of the current social media networks.

### SUMMARY OF THE INVENTION

Accordingly, one aspect of the invention discloses a system for the intelligent facilitation of speech synthesis and speech recognition with real-time auto translation on social media platform wherein the aforesaid system comprises:
(a) a module for creating post on social media;
(b) a module for creating personal security group for controlling sharing the posts;
(c) a module for identifying any post in its intended group;
(d) a module for identifying near by contacts via locating on a in-built map;
(e) a module for facilitation of speech synthesis along with speech and text recognition with an additional feature of transcription and vice versa;
(f) A module for the real time and instant translation of the fed information while retaining the original source of the information;
   wherein, the aforesaid modules of the system described herein implies the functionalities in its texting feature.

In another aspect of the present invention, the user of the aforesaid system can create post in any language of his preference.

In another aspect of the present invention, the aforesaid system can be operated in all possible national language of user.

In another aspect of the present invention, the input posts are selected from the group consisting of image, video, gifs, audio, files, text, document etc.

In another aspect of the present invention, user of the aforesaid system can create as many groups of their choice and can assign users of the each group.

In another aspect of the present invention, the user can opt and set up their preferred language in their profile and enable the translation button, thereafter can operate the system in their preferred language after translation.

In another aspect of the present invention, the aforesaid system facilitates speech synthesis along with speech and text recognition otherwise termed as the conversion of text to audio and audio to text.

In another aspect of the present invention, the aforesaid system modulates the translation of any audio and video post in any language.

In another aspect of the present invention, the aforesaid system allows user to forward information to their contacts, while retaining the information about original author of the post.

In another aspect of the present invention, the messaging option facilities the real-time instant translation of the audio, video and texting information while converting audio to text and text to audio facility.

In another aspect of the present invention, the user can share documents, voice, commands, can arrange conference calls and may include more than 4 users with a simple user interface and intelligent use of the speaker icon.

In another aspect of the present invention, the aforesaid system is operated and utilised in several multi media devices can include mobile, hand held or portable devices or non-portable devices and can be any of, but not limited to, a server desktop, a desktop computer, a computer cluster, or portable devices including, a notebook, a laptop computer, a handheld computer, a palmtop computer, a mobile phone, a cell phone, a smart phone, a PDA, a Blackberry™ device, a Treo™, a handheld tablet (e.g. an iPad™, a Galaxy™, Xoom™ Tablet, etc.), a tablet PC, a thin-client, a hand held console, a hand held gaming device or console, an iPhone, and/or any other portable, mobile, hand held devices, etc.

### DESCRIPTION OF THE INVENTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms.

The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains.

Embodiments of the present disclosure include a system for intelligent facilitation of speech synthesis and speech recognition with auto-translation on a social media platform. In one embodiment of the present invention, the aforementioned system's primary objective is the ability to translate instantly any post in the language of users' choice. The aforesaid user may have to set up the preferred language in his or her profile and enable the translation button. Once the preference is set, all the post user sees is translated in the language user has chosen. The aforementioned system retains the original text original text in the original language is retain that user can view with single click. Further, the system provides language choice drop down list and enable/disable switch. Further, the aforesaid system provides facilitation in speech synthesis and speech recognition i.e. the feature of converting text to audio and audio to text respectively.

The further feature of the above mentioned system is to translate any audio and video posts in any language. In another embodiment of the present invention, the aforementioned system, retainers the original creator of a content that is being circulated broadly.

According to a first aspect of the present invention there is provided a method for text-to-speech synthesis with personalized voice, comprising: receiving an incidental audio input of speech in the form of an audio communication from an input speaker and generating a voice dataset for the input speaker; receiving a text input at a same device as the audio input; synthesizing the text from the text input to synthesized speech including using the voice dataset to personalize the synthesized speech to sound like the input speaker.

Preferably, the method includes training a concatenative synthetic voice to sound like the input speaker. Personalising the synthesized speech may include a voice morphing transformation.

The audio input at a device is incidental in that it is coincidental in an audio communication and not a dedicated input for voice training purposes. A device has both audio and text input capabilities so that incidental audio input from audio communications can be received at the same device as the text input. The device may be, for example, an instant messaging client system with both audio and text capabilities, a mobile communication device with both audio and text capabilities, or a server which receives audio and text inputs for processing.

In one embodiment, the audio input of speech has an associated visual input of an image of the input speaker and the method may include generating an image dataset, and wherein synthesizing to synthesized speech may include synthesizing an associated synthesized image, including using the image dataset to personalize the synthesized image to look like the input speaker image. The image of the input speaker may be, for example, a still photographic image, a moving video image, or a computer generated image.

Additionally, the method may include analyzing the text for expression and adding the expression to the synthesized speech. This may include storing paralinguistic expression elements from the audio input of speech and adding the paralinguistic expression elements to the personalized synthesized speech. This may also include storing visual expressions from the visual input and adding the visual expressions to the personalized synthesized image. Analyzing the text may include identifying one or more of the group of: punctuation, letter case, paralinguistic elements, acronyms, emotion icons, and key words. Metadata may be provided in association with text elements to indicate the expression. Alternatively, the text may be annotated to indicate the expression.

The aforementioned system may be installed and utilised in several multi media devices can include mobile, hand held or portable devices or non-portable devices and can be any of, but not limited to, a server desktop, a desktop computer, a computer cluster, or portable devices including, a notebook, a laptop computer, a handheld computer, a palmtop computer, a mobile phone, a cell phone, a smart phone, a PDA, a Blackberry™ device, a Treo™, a handheld tablet (e.g. an iPad™, a Galaxy™, Xoom™ Tablet, etc.), a tablet PC, a thin-client, a hand held console, a hand held gaming device or console, an iPhone, and/or any other portable, mobile, hand held devices, etc.

In another embodiment, any message or content resulting from or as the basis of activities between users and a network resource (e.g., content provider, networking site, media service provider, online promoter, etc.) can be analyzed for which analytics can be used for various applications including, content/message personalization/customization and filtering, trend/popularity detection (on certain sites, across all sites or select sets of sites, over a certain time period, in a certain geographical locale (e.g., in the United State), as relating to a certain topic (e.g., what's trending in sports right now), etc.) or a combination of the above.

Additional applications include targeted advertising from a user-driven facet, platform-driven facet, timing-facet, delivery-style/presentation-style-facet, advertiser-facet, or any combination of the above.

In general, the host server 100 operates in real-time or near real-time and is able to generate useful analytics/statistics regarding network or online activity to detect current trends or predict upcoming trends for various applications. Delay time analytics and statistics can also be extracted in any specified timing window. In one embodiment, message/content analytics can also be used in generating unique user interfaces and UI features useful for displaying trends or popular topics/types/people/content in an intuitive manner for navigation.

In one embodiment, communications to and from the system can be achieved by an open network, such as the Internet, or a private network, such as an intranet and/or the extranet. In one embodiment, communications can be achieved by a secure communications protocol, such as secure sockets layer (SSL), or transport layer security (TLS).

In addition, communications can be achieved via one or more networks, such as, but are not limited to, one or more of WiMax, a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), enabled with technologies such as, by way of example, Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G, 4G, IMT-Advanced, pre-4G, 3G LTE, 3GPP LTE, LTE advanced, mobile WiMax, WiMax 2, WirelessMAN-Advanced networks, enhanced data rates for GSM evolution (EDGE), General packet radio service (GPRS), enhanced GPRS, iBurst, UMTS, HSPDA, HSUPA, HSPA, UMTS-TDD, 1 xRTT, EV-DO, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols.

The statistics or any qualitative data computed as a function of time in a given time period or in real time can be used to detect trends (e.g., via the trending engine), potential trends or upcoming trends from any set of messages or online activity. For example, sets of messages relating to a given user can be analyzed to identify trends in the user's interest. Messages/content relating to a given platform can be analyzed to detect what is popular on that site right now. Messages/content relating to a specific topic (e.g., sports) can be analyzed to identify what's currently popular or trending in sports news.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

Improvements and modifications can be made to the foregoing without departing from the scope of the present invention.

What is claimed is

1. A system for the intelligent facilitation of speech synthesis and speech recognition with real-time auto translation on social media platform wherein the aforesaid system comprises:
(a) a module for creating post on social media;
(b) a module for creating personal security group for controlling sharing the posts;
(c) a module for identifying any post in its intended group;
(d) a module for identifying near by contacts via locating on a in-built map;
(e) a module for facilitation of speech synthesis along with speech and text recognition with an additional feature of transcription and vice versa;
(f) A module for the real time and instant translation of the fed information while retaining the original source of the information;
wherein, the aforesaid modules of the system described herein implies the functionalities in its texting feature.

2. The system as claimed in claim 1 wherein, the user of the aforesaid system can create post in any language of his preference.

3. The system as claimed in claim 1 wherein, the aforesaid system can be operated in all possible national language of user.

4. The system as claimed in claim 1 wherein, the input posts are selected from the group consisting of image, video, gifs, audio, files, text, document etc.

5. The system as claimed in claim 1 wherein, user of the aforesaid system can create as many groups of their choice and can assign users of the each group.

6. The system as claimed in claim 1 wherein, the user can opt and set up their preferred language in their profile and enable the translation button, thereafter can operate the system in their preferred language after translation.

7. The system as claimed in claim 1 wherein, the aforesaid system facilitates speech synthesis along with speech and text recognition otherwise termed as the conversion of text to audio and audio to text.

8. The system as claimed in claim 1 wherein, the aforesaid system modulates the translation of any audio and video post in any language.

9. The system as claimed in claim 1 wherein, the aforesaid system allows user to forward information to their contacts, while retaining the information about original author of the post.

10. The system as claimed in claim 1 wherein, the messaging option facilities the real-time instant translation of the audio, video and texting information while converting audio to text and text to audio facility.

11. The system as claimed in claim 1 wherein, the user can share documents, voice, commands, can arrange conference calls and may include more than 4 users with a simple user interface and intelligent use of the speaker icon.

12. The system as claimed in claim 1 wherein, the aforesaid system is operated and utilised in several multi media devices can include mobile, hand held or portable devices or non-portable devices and can be any of, but not limited to, a server desktop, a desktop computer, a computer cluster, or portable devices including, a notebook, a laptop computer, a handheld computer, a palmtop computer, a mobile phone, a cell phone, a smart phone, a PDA, a Blackberry™ device, a Treo™, a handheld tablet (e.g. an iPad™, a Galaxy™, Xoom™ Tablet, etc.), a tablet PC, a thin-client, a hand held console, a hand held gaming device or console, an iPhone, and/or any other portable, mobile, hand held devices, etc.
